(19) United States
(12) Patent Application Publication
(10) Pub. No.: US 2009/0120872 A1
(43) Pub. Date: May 14, 2009

(54) COMPOSITION AND BIOREMEDIATION METHOD FOR WATER POLLUTED BY HYDROCARBONS

(75) Inventor: Werner Kroh, Enggistein (CH)

Correspondence Address: SPECKMAN LAW GROUP PLLC, 1201 THIRD AVENUE, SUITE 330, SEATTLE, WA, 98101, US

(73) Assignee: SWISSTECH HOLDING AG, Zug (CH)

(21) Appl. No.: 12/092,953

(22) PCT Filed: Nov. 1, 2006
(86) PCT No.: PCT/CH2006/000614

§ 371 Date: Aug. 15, 2008

(30) Foreign Application Priority Data
Nov. 7, 2005 (CH) 01779/05
Nov. 8, 2005 (CH) PCT/CH2005/000658
Sep. 15, 2006 (CH) 1473/06

(51) Int. Cl. C02F 1/28; C02F 101/32; B01J 20/10

(52) U.S. Cl. 210/631; 435/243; 502/407

(57) ABSTRACT

The invention relates to a novel composition and a novel method for the in situ bioremediation of water polluted by hydrocarbons, in particular oil. To remove, for example, an oil slick that is floating on the surface of a body of water, the new composition can be dispersed in powder form over said oil slick. The inventive composition binds spontaneously with the oil, sinking together with the latter below the surface of the water to finally settle as a fine sediment on the bottom. Within a few hours the toxic hydrocarbons have been eliminated from the water, in such a way that in the case of freshwater, drinking-water quality can be restored. The microbiological degradation takes place in situ. The composition contains silicon carbide and/or silicon dioxide in powder form and preferably additives including granite dust, silica-lime dust and calcium. Said new composition permits a simple, cost-effective bioremediation of oil pollution on the surface of bodies of water. Oil pollution can now be controlled for the benefit of man and his environment, even in underdeveloped and newly industrialized countries, which have previously been neglected for financial reasons.

### TECHNICAL FIELD

The present invention relates to a composition for bioremediation of water contaminated with hydrocarbons, in particular with crude oil. The invention also relates to a method for the bioremediation of waters contaminated with hydrocarbons, in particular with crude oil.

### STATE OF THE ART

The transport of crude oil and its various fractions from the production locations or from the centres of production to the consumer is a risky business, and over longer distances is effected by oil tankers and pipelines. With damage to oil tankers at sea, which occurs again and again, millions of tons of crude oil may be released. Large quantities of oil get into the sea or inland waters when pipelines suffer from leakage or are attacked, and have a catastrophic effect on the ecological systems. Serious damage to the environment also occurs however with oil contamination of a less catastrophic magnitude, such as sometimes occurs unfortunately when the oil tanks are illegally flushed out at sea. Especially the coastal regions oil contamination leads to severe economical and social consequences.

With regard to this, it is not only the case of freeing the water contaminated with oil from this oil, as is known e.g. with the known suctioning methods, but one rather strives for a simple, final and environmentally satisfactory clearing-up of the oil and the toxic hydrocarbons contained therein. Until now, the subsequently listed measures are applied for the disposal of the oil floating on contaminated waters.

1. Suctioning or mechanically collecting the leaked oil by way of specialised ships, and the subsequent removal and disposal.
2. Binding and/or stabilising the free-floating oil with oleophilic or hydrophobically treated powder- or fibre mixtures on the surfaces of the waters, and the subsequent collection, removal and disposal thereafter.

In practise however, one may suction, remove and possibly dump or incinerate only a small part of the oil. Furthermore, the storage and the incineration is often carried out without due attention to the ecological compatibility, so that this measure in turn meets with considerable resistance of the public. In the meanwhile, waste sites for such critical waste are also lacking in many countries, and such a disposal of freely floating oil is forbidden by law in many countries.

A whole series of means and method for binding oil contamination on the surfaces of waters are known. With regard to the description of these binding agents, in the state of the art, the terms adsorption and absorption are often not differentiated from one another in a sufficiently unambiguous manner. The accumulation of a sorptive onto the surface of a sorbent is to be indicated as adsorption, and the accommodation of a sorptive into the inside of a sorbent is to be indicated as absorption. The material to be sorbed thereby is to be indicated as the sorptive, and the sorbing material as the sorbent or sorption agent, and the accommodated or bonded material as sorbat.

Today, absorbents (absorbing agents) are generally suggested for binding oil contamination on water, which may accommodate an as large as possible volume of oil per volume of binding agent and which may be suctioned from the surface of the water in the fully soaked condition. Since most of the known means with large inner surfaces are hydrophilic or amphiphilic, they must first be rendered oleophilic and/or hydrophobic, which requires considerable effort. Such absorbing agent based on expanded and subsequently siliconised perlite or vermiculite granules have already been known in DE-2845975 from the year 1980 for use as an agent for soaking up oil. It is suggested in DE-2314616 to apply crumbs of a celled polystyrene foam with a density of 2.24×10⁻² and 3.21×10⁻² g/cm³ as an absorbing agent for oily, fluid hydrocarbons. The use of polystyrene foam granules is also known from U.S. Pat. No. 3,756,948. Numerous absorbing agents are known from literature, which have the most varied of base materials and additives. Thus for example U.S. Pat. No. 3,630,891 describes hydrophobically treated wood fibres, and U.S. Pat. No. 3,591,524 an agent based on cellulose which is hydrophobically treated with an oil in water emulsion, ammonium-containing emulsion, or an amine-containing emulsion. Porous coconut fibre material which is treated with an oleophilic and hydrophobic substance is applied for binding oil contamination on waters in U.S. Pat. No. 4,172,039. It is moreover suggested to fill containers with this material and to let them drift on the surface of the water and thereby to absorb the oil. A granular absorbing agent is described in U.S. Pat. No. 6,087,301, which apart from a perlite-plaster aggregate, contains maize starch and baking powder.

It has been shown in practical application that the bonded oil-absorbing agent mass which floats on the surface of the water is extremely difficult to handle and that the absorbed oil may only be desorbed from the absorbent again only with a very considerable effort.

An adsorbing agent based on TiO₂ is disclosed in U.S. Pat. No. 6,030,536, wherein this adsorbing agent is only applied after the removal of the oil contamination from the surface of the water. The highly viscous water-crude oil mixture which contains up to 90% sea water is separated in the laboratory or in suitable industrial means with the TiO₂-containing adsorbing agent. The crude oil attaches to the adsorbing agent which is subsequently recycled in a multi-stage process. ZrO₂ and Al₂O₃ are further mentioned as adsorbent in the patent document.

Since an effective removal of oil contamination just as the subsequent treatment and disposal of the often toxic binding agent—crude oil mixtures requires much effort and is cost-intensive, one mainly forgoes it in many regions of the earth. The result of this is the fact that the initial contamination on a water surface with all its negative effects on the marine and limnic ecological systems also leads to the contamination of wide coastal regions with enormous costs to humans and the environment. It is indeed in developing countries and emerging nations where a huge need for new, inexpensive and effective means and methods for combating oil contamination on the surfaces of waters exists.

It is therefore the object of the present invention to provide a composition and a method for bioremediation of water contaminated with hydrocarbons, in particular with crude oil, which does not have the disadvantages mentioned above.

### DESCRIPTION OF THE INVENTION

A new solution for the previously mentioned problem and the task which is derived from it is specified by the present invention as is characterised in the patent claims. The new composition and the new method permit an in situ bioremediation. This means to say that the crude oil is not only bonded, but the biological decomposition on location is not only accelerated, but is often rendered possible at all in the first place.

A composition according to the invention is a product that can be efficiently applied for the complete removal of spilled crude oil, also in port facilities or for tank ship accidents. The market-ready product is a dry, free flowing mixture of solids, comprising a composition of natural mineral raw materials, naturally occurring as solids. These raw materials are obtained from primary or secondary deposits (quarries, stone pits, or other mineral deposits). They may also be recycled from certified non-contaminated natural mineral raw materials. Preferably the natural mineral raw materials are not thermally or chemically pre-treated or treated.

The natural mineral raw materials, as a single compound, as mixtures, and in the final composition according to the invention, are chemically inert under natural surrounding conditions (on land, in the water, on ice). During long-time storage, transport, application, and also disposal they are thus completely harmless for people, animals, plants, and the environment.

For the manufacture of the compositions according to the invention the natural mineral raw materials are solely broken down, milled, and grinded to the necessary particle size efficiently working from the invention. It results a total particle surface of the compositions, to which the polluting hydrocarbons, particularly crude oil, may adhesively attach in a quantitatively optimal manner (monomolecular level).

For combating an oil slick floating on a water surface, it is sufficient to scatter or blow the composition according to the invention over the oil slick. The composition according to the invention specifically has the advantageous and amazing characteristic that it spontaneously combines with the oil, and the sorbat without the formation of larger lumps sinks from the surface of the water to the bed of the water and settles there as a fine sediment. With the application of adequate quantities of the composition according to the invention, one may ascertain hardly any toxic hydrocarbons at all in the treated water within a few hours or days. Laboratory trials have even shown that one may even achieve drinking water quality.

The oil is broken down into microscopically small parts by way of the new composition according to the invention. The powder particles bind the oil particles by adsorption, by way of arranging themselves around the oil droplet. Due to the higher specific weight of the powder according to the invention which is preferably between 2.5 and 3.5, preferably about 3.0, the parts of the oil-powder complex completely sink to the bed of the respective water. The present invention utilises the physisorption, a special form of adsorption, with which the sorptive is bonded by way of physical forces and not the formation of chemical bondings to the sorbent. The physical forces acting here, as a rule are not directed and have the advantage that the bondings are reversible. The sorptive may thus be released from the sorbent again, which encourages the microbial breakdown of the oil.

The sunk oil may also neither be separated from the composition according to the invention by way of violent turbulence, and thus may no longer drift to the surface of the water.

Since the crude oil is adsorbed onto the particles of the composition, the effective surface which is available for attack by the micro-organisms breaking down the oil, is increased enormously. By way of this the breakdown of the oil is rendered possible, and is accelerated enormously until a complete decomposition of the oil. The microscopically small droplets serve as a substrate for the profuse development of the micro organisms taking part in the breakdown. The oil is broken down without any residue within 3 to 4 months, depending on the geological region and the prevailing environmental conditions. The biodegradation or the remediation therefore preferably takes place in situ. The difficult and cost-intensive suctioning of the oil-binding agent mixtures from the surface of the water and the subsequent disposal, dumping and reprocessing of this highly problematic waste which as mentioned above, which often leads to the fact that no measures at all are taken for cleaning oil contaminations, are rendered superfluous by way of the inventive in situ decomposition of the toxic hydrocarbon compound.

Micro-organisms which are suitable for the decomposition of crude oil or other hydrocarbon contamination are added to the composition, and form an important constituent of the product in one advantageous embodiment. The micro-organisms are formulated such that its storage capability and flowing ability are ensured. The formulation is preferably effected in the form of pellets or capsules. In particular, national or local regulations are to be observed and adhered to with the application of non-indigenous micro-organisms. Since these may be admixed without any problem into the suitable flowable formulation, even on location, the micro-organism constituent may be adapted to the regulations which apply to the respective location of application without significant effort.

The exact composition of the product in powder form and the grain size of the constituents is preferably adapted to the nature of the oil to be removed.

The composition with a specific weight of about 3 g/cm³ is a composition of various rock or naturally occurring minerals in powder form. One essential main component of the composition according to the invention is selected from the following group: silicon carbide (SiC), silicon (Si) or silicon dioxide (SiO₂). All three substances under normal environmental conditions are inert chemical compounds and have a specific weight of 2.33 g/cm³ (Si), 2.7 g/cm³ (SiO₂) and 3.22 g/cm³ (SiC). The grain size of the individual constituents or components of the composition according to the invention preferably lies between 100 to 600 micrometers. At least more than 50% of the composition should be present in powder form below 400 micrometers.

The following percentage portions for the individual, previously mentioned components (in percentage by weight) have been shown to be favourable or possible:

| | |
|---|---|
| 0-40% | silica sand (SiO₂) |
| 0-60% | silicon carbide (SiC) |
| 5-40% | granite meal |
| 5-40% | meal of siliceous limestone |

2 to 14% by weight of calcium carbonate (CaCO₃) may be added as an optional component of preferred embodiments of the composition. The meal of siliceous limestone may be partially or fully replaced by CaCO₃ in the form of marble meal.

According to a first preferred embodiment, the following composition is preferred within the predefined limits:

20% silica sand (SiO₂)

20% SiC

40% granite meal

15% meal of siliceous limestone

5% CaCO₃

The agent specified by the invention according to a preferred embodiment contains silicon carbide with a hexagonal crystal structure.

By increasing in the portion of granite meal or SiO₂, preferably in the form of silica sand, one may save or replace a percentage portion of silicon carbide, and by way of the meal of siliceous limestone mainly the affinity of the agent according to the invention to oil is increased.

For this reason, the following composition is suggested as a further preferred embodiment within the previously mentioned limits:

40% silica sand (SiO₂)

40% granite meal

15% meal of siliceous limestone

5% CaCO₃

And particularly preferred:

20% silica sand (SiO₂)

40% granite meal

20% meal of siliceous limestone

20% CaCO₃, preferably as marble meal

whereby in other embodiments the meal of siliceous limestone is replaced at least partially by clay, particularly brick or clinker clay.

As mentioned above, the grain size of the silicon carbide and/or SiO₂ as well as also that of the other applied substances should preferably be between 60 and 600 micrometers. Preferably more than 50% of all particles should lie in a size range of below 350 micrometers. In a particularly preferred embodiment of the composition nearly all particles have a size in a size range of below 350 micrometers.

Since with the application of the SiO₂, which is less expensive but lighter compared to SiC, the specific weight of the composition is reduced, in a preferred embodiment, 10 to 15% of the granite meal is replaced by garnet sand with a specific weight of 4.1 g/m³.

The components described above are composed as following:
Component: siliceous limestone

| | portion | |
|---|---|---|
| | in % | |
| mineral content | by weight | chemical formula |
| quartz/silicon | 25 | SiO₂ |
| calcite | 65 | CaCO₃ |
| dolomite | 1 | CaCO₃MgCO₃ |
| pyrite | 1 | FeS |
| clay (montmorillonite) | 5 | (Na,Ca)(Al,Mg)₂Si₄O₁₀(OH)₂4H₂O |
| organic substances | 3 | complex (CₓH_{y}S_{z})-compounds |

Component: silicon carbide

| mineral content | portion in % by weight | chemical formula |
|---|---|---|
| silicon | 50 | Si |
| carbon | 50 | C |

Component: silica sand

| mineral content | portion in % by weight | chemical formula |
|---|---|---|
| quarz/silicon | 100 | SiO₂ |

Component: granite

| | portion in % | |
|---|---|---|
| mineral content | by weight | chemical formula |
| quarz/silicon | 40 | SiO₂ |
| felspar series | 50 | (K,Na,Ca)(AlₓSi_{y}O₂) |
| (plagioclase/orthoclase) | | |
| mica series | 10 | (K,Alₓ,Mg_{y})(F,OH)₂(AlSi₃O₁₀) |
| (muscovite/biotite) | | |

The following optional components may be applied in further embodiments:

Component: garnet sand

| mineral content | portion in % by weight | chemical formula |
|---|---|---|
| almandine | 100 | (Fe,Ca,Mg)ₓAl₂(SiO₄)₃ |

In an advantageous embodiment. 10 to 15% of the granite meal has been replaced by garnet sand.

Compositions according to preferred embodiments of the present invention are disclosed in the following table, with further features and preferred ranges (in the table called bandwidths):

| raw material | chemical comp. | bandwidth of Portions | optimum portions | bandwidth of particle sizes |
|---|---|---|---|---|
| (stone/mineral) | (formula) | (% by weight) | (% by weight) | (μm) |
| Siliceous limestone | | 5-35% | 20% (+/−2.5%) | 80-100 μm |
| compounds: | | | | |
| quartz: | SiO₂ | 42% (+/−2.5%) | | |
| calcium: | CaCO₃ | 46% (+/−2.5%) | | |
| dolomite: | Ca,Mg(CO₃)₂ | 1% (+/−2.5%) | | |
| glauconite: | (K,Na)(Fe,Al,Mg)₂(OH)₂(Si,Al)₄O₁₀ | 1% (+/−2.5%) | | |
| clay (montmorillonite) | (Na,Ca)(Al,Mg)₂Si₄O₁₀(OH)₂4H₂O | 5% (+/−2.5%) | | |
| pyrite/iron: | FeS₂/Fe₂O₃ | 1% (+/−2.5%) | | |
| organic compounds: | (CₓH_{y})-complexes | 1% (+/−2.5%) | | |
| various minerals: | (silicates) | 3% (+/−2.5%) | | |
| Quartz | | 5-35% | 20% (+/−2.5%) | 100-160 μm |
| compounds: | | | | |
| quartz: | SiO₂ | 100% | | |
| Limestone | | 5-35% | 20% (+/−2.5%) | 200-300 μm |
| compounds: | | | | |
| calcium: | CaCO₃ | 100% | | |
| Granite | | 20-60% | 40% (+/−2.5%) | 150-350 μm |
| compounds: | | | | |
| quartz: | SiO₂ | 35% (+/−2.5%) | | |
| K-feldspar: | K(AlSi₃O₈) | 29% (+/−2.5%) | | |
| Na-feldspar: | Na(AlSi₃O₈) | 29% (+/−2.5%) | | |
| mica: | (K,AlₓMg_{y})(F,OH)₂(AlSi₃O₁₀) | 4% (+/−2.5%) | | |
| hornblende: | Ca₂(Fe,Mg)₄Al(Si₇Al)O₂₂(OH,F)₂ | 3% (+/−2.5%) | | |

As already mentioned, the natural mineral compounds mentioned above may be partially or fully replaced by similar mineral compounds of other natural resources, or may be combined with the same natural mineral compounds of other sources.

It has been found that by particle size fractioning of the single natural mineral compounds that are used in the compositions according to the invention, and mixing these, an optimum bulk weight may be achieved, which after the adhesion process results in the sinking of the polluting crude oil in the water (salt water and fresh water).

| | | bulk weight (resulting from |
|---|---|---|
| raw material | specific weight | the particle size fractioning) |
| siliceous limestone | 2.67 | 0.90 |
| quartz | 2.65 | 0.90 |
| lime | 2.50 | 0.84 |
| granite | 2.70 | 0.91 |
| Ø | 2.64 | 0.89 |

It has been found that for the adhesion process an average specific weight of the composition according to the invention of 2.64 is advantageous.

Preferred 6 to 10 kg, particularly preferred 8 kg, of the composition according to the invention are applied for 1 kg of polluting crude oil.

### TEST EXAMPLE 1

Normal tap water (freshwater) is set to the usual salt content of sea water by way of the addition of sea salt.

20 ml of crude oil is added to a litre of the thus obtained salt water in a test vessel amid weak stirring.

So much agent according to the invention in the composition mentioned above was scattered onto the oil, floating essentially on the surface of the salt water (a part of the oil however was also distributed in the water in the form of small droplets), that the complete oil layer floating on the water surface was covered with a roughly uniformly thin layer of the agent according to the invention.

Already a few seconds after scattering an agent according to the invention with 40% silica sand (grain size 0.2 to 0.3 mm), 40% granite meal, 15% meal of siliceous limestone, and 5% CaCO₃, the agent bonded to the oil, disappeared from the surface of the water and as a result slowly fell to the bottom of the test vessel as a fine sediment. The water became rapidly clearer and oil could no longer be ascertained in the water optically as well as by smell, already after about 1 day. The oil was completely bonded in the sediment.

### TEST EXAMPLE 2

Normal tap water (freshwater) is set to the usual salt content of sea water by way of the addition of sea salt.

20 ml of crude oil is added to a litre of the thus obtained salt water in a test vessel amid weak stirring.

So much agent according to the invention in the composition mentioned above was scattered onto the oil, floating essentially on the surface of the salt water (a part of the oil however was also distributed in the water in the form of small droplets), that the complete oil layer floating on the water surface was covered with a roughly uniformly thin layer of the agent according to the invention.

Already a few seconds after scattering, an agent according to the invention with 40% SiC, 40% granite meal, 15% meal of siliceous limestone and 5% CaCO₃, the agent bonded to the oil, disappeared from the surface of the water and as a result slowly fell to the bottom of the test vessel as a fine sediment. The water became rapidly clearer and oil could no longer be ascertained in the water optically as well as by smell, already after about 1 day. The oil was completely bonded in the sediment.

A sample (500 ml) of the water treated with the agent according to the invention was gathered after 2 days.

The water sample was washed via a C18-column and an aliquot of the eluent was examined for traces of oil in an instrumental-analytical manner. This was effected via a gas chromatography mass spectrometer system of the company Hewlett Packard. After the capillary gas chromatographical separation, the masses 43 and 58 were detected in an ion-selective manner. Only 0.05 mg/litre of these masses, i.e. of hydrocarbon- or oil residues resulted in the examined water sample.

0.02 mg/litre of hydrocarbons was detected in a salt water reference sample, to which no oil was added and also accordingly none of the agent according to the invention.

According to the regulations which apply in Switzerland today concerning the maximal permissible hydrocarbon content, the limit values for water being issued into the sewage system is 20 mg/litre, for water being issued in waters such as rivers and lakes 10 mg/litre, and for flowing waters and river ponds 0.05 mg/litre. A value of 0.01 to 0.05 mg/litre is assumed for drinking water. Since only 0.05 mg/litre of hydrocarbons was found in the examined sample, this is comparable to the quality targets for drinking water.

### Test on the Effectiveness of the Bioremediation

The environmentally harmful hydrocarbons may be broken down in a natural manner and within a short period of time with the composition according to the invention. The observations which have been made with the internal trials which are described above, lead to the conclusion that the natural decomposition of the hydrocarbons takes place in an accelerated manner under the application of the composition according to the invention, or is rendered possible in the first place by way of this. In a bioremediation effectiveness test according to US Environmental Protection Agency (EPA) Protocol (according to 40 CFR Chapter 1(7-1-99) Pt. 300 Appendix C, Item 4.0) it was proved by the independent certified test laboratory Bio-Aquatic Testing in Carrollton, Tex., USA, that the treatment with the composition according to the invention (40% SiC, 40% granite meal, 15% meal of siliceous limestone and 5% CaCO₃) of sea water contaminated with crude oil, within 28 days led to a reduction of the alkanes by 46.6% with respect to untreated control samples. The reduction in the aromatic compounds with the oil-contaminated sea water samples treated with the composition according to the invention was even 86.6% above the value of the untreated controls. With the treated samples, a reduction of the oil mass by 52.5% occurred in comparison to the untreated control groups. With regard to the oil which was applied in the trials, it was the case of Alaska North Slope 521 as may be obtained from EPA Environmental monitoring by Support Laboratory in Cincinnati, Ohio, USA.

According to the invention the compositions are deposited on the oil surfaces to be treated by way of suitable apparatus, preferably in the form of a free flowing powder. With trials, blowers, as they are applied for example for sand blasting, have been found useful. With this, depending on the type and nature of the oil, the individual constituents of the composition according to the invention may be varied on location. This means that the composition is not brought to the location of application mixed, but on location it is mixed together from the individual components, preferably by way of the sand blasting blower.

It is to be understood that, as the case may be, the mixture may be put together in a different manner for the respective application purpose and taking into account the nature of the oil to be removed. Apart from sinking and binding oil floating on a water surface by way of scattering over the oil, the agent according to the invention may of course also be used for other specific purposes or differently from the described manner on account of its advantageous properties. E.g. the means may be applied also for a contamination of earth with oil or with hydrocarbons, for reducing oil or hydrocarbons in water of every type or very generally for improving the water quality.

1. A composition for the bioremediation of water contaminated with hydrocarbons, characterised in that the composition comprises silicon carbide (SiC) and/or silicon dioxide (SiO₂) in powder form.

2. The composition according to claim 1, characterised in that it comprises a mineral powder selected from the group: (K,Na,Ca) (AlₓSi_{y}O₂) and/or (K, Alₓ, Mg_{y}) (F,OH)₂ (AlSi₃O₁₀).

3. The composition according to claim 2, characterised in that the mineral powder is granite meal.

4. The composition according to claim 1, characterised in that it comprises a mineral powder selected from the group: SiO₂, CaCO₃, CaCO₃MgCO₃, FeS and/or (Na,Ca)(Al,Mg)₂ Si₄O₁₀(OH)₂ Si₄H₂O.

5. A composition according to claim 4, characterised in that the mineral powder is meal of siliceous limestone, and/or silica sand.

6. The composition according to claim 1, characterised in that it comprises 5-35% by weight of silica sand, 25-60% by weight of granite meal and 10-70% by weight selected from the group: meal of siliceous limestone, limestone, marble, or mixtures thereof.

7. The composition according to claim 6, characterised in that it comprises 20-60% by weight of granite powder, 5-35% by weight of silica sand, 5-35% by weight of lime, and 5-35% by weight of meal of siliceous limestone.

8. The composition according to claim 7, characterised in that it comprises 20% by weight of silica sand, 40% by weight of granite meal, 20% by weight of meal of siliceous limestone and 5% by weight of lime.

9. The composition according to claim 1, characterised in that it comprises 40% by weight of silicon carbide, 40% by weight of granite meal, 15% by weight of meal of siliceous limestone and 5% by weight of lime.

10. The composition according to claim 3, characterised in that 10-15% of the granite meal are replaced by garnet sand.

11. The composition according to claim 1, characterised in that the grain size of the individual components lies between 60 and 600 micrometers, wherein preferably in each case more than 50% of the individual particles lie in the range below 350 micrometers.

12. The composition according to claim 1, characterised in that the composition is a free-flowing powder.

13. The composition according to claim 1, characterised in that oil-decomposing micro-organisms are added in the form of pellets or capsules.

14. A method for the bioremediation of water bodies contaminated with hydrocarbons, with a composition according to claim 1, wherein the composition is applied as a sorbent directly onto the contamination to be removed, so that the hydrocarbons are adsorbed, and sink with the sorbent, by which means the water is approximately completely freed from the contamination.

15. The method according to claim 14, characterised in that the adsorbed hydrocarbons, is decomposed in situ.

16. The method according to claim 14, characterised in that 8 kg of the composition according to one of the claims 1 to 13 is applied for each 1 kg of hydrocarbons.
